(19) United States
(12) Patent Application Publication
(10) Pub. No.: US 2016/0037001 A1
(43) Pub. Date: Feb. 4, 2016

(54) SYSTEM AND METHOD FOR DIGITALLY STORING DATA

(71) Applicant: MemoryMemo LLC, Charlotte, NC (US)

(72) Inventors: Henry Mummaw, Charlotte, NC (US); Greg Robey, Charlotte, NC (US)

(21) Appl. No.: 14/814,853

(22) Filed: Jul. 31, 2015

Related U.S. Application Data
(60) Provisional application No. 62/031,918, filed on Aug. 1, 2014.

(51) Int. Cl. H04N 1/00; H04N 5/225; H04N 5/77

(52) U.S. Cl. CPC H04N 1/00244; H04N 5/77; H04N 5/225; H04N 1/00265; H04N 1/00251; H04N 2201/0084

(57) ABSTRACT

An apparatus configured to digitally store data is disclosed. The apparatus including an image capturing device configured to capture image data and content data associated with the image data thereon and a software application disposed on the image capturing device. The software application includes a plurality of software functions configured to allow a user to capture and modify the image data and content data. The software functions compile the image data and content data into a single folder having a unique file extension for use by the user.

### BACKGROUND OF THE INVENTION

The present invention relates generally to a system and method for digitally storing data. More specifically, the present invention relates to a system and method for digitally storing, managing, printing and presenting historical data of digital photographs and videos using a unique file structure that combines image and video files with audio and text files to capture the entire historical context of the event.

Cameras and social media have changed the way society interacts. For example, sporting events are using helmet cameras and/or car mounted cameras to provide a viewer with an up close and more immersive view that allows the viewer to see what the athlete wearing the camera sees. Cell phone cameras are being used to record and post live events to social media.

People often take photographs and videos to help capture and remember a moment in time because photographs and videos can be stored and revisited indefinitely. Photography by its very nature is an event—something is occurring that, at the moment, is important enough to be memorialized. It could be spontaneous, trivial or profound, but it is an event; and, as a result, people take multiple photographs and videos to capture many moments. Unfortunately, often times, it is difficult to remember information about a photograph, such as the people in it or the event that it commemorates.

Present methods of recording and storing information with a photograph are ineffective. Currently, recording and retrieving information associated with photographs means manually typing in the name of the photograph or other information relating to the photograph in a file that may, or may not, be attached to the photograph file and could easily be separated and lost, or making handwritten notes on the back of photo prints and slides. These methods are cumbersome and can be very tedious. Further, it detracts from the consumer focusing on capturing memories with photographs.

Currently, there is no known system and method that effectively and efficiently stores, effectively manages, prints and presents data of digital photographs and videos using text or audio in the same file. Accordingly, there is a need for a system and method for digitally storing, managing, printing and presenting historical data of digital photographs and videos.

### BRIEF SUMMARY OF THE INVENTION

These and other shortcomings of the prior art are addressed by a system and method that integrates with the software of smartphones, tablets, digital cameras, and any other suitable digital camera, video recorder, computer, etc. to digitally store, manage, present and edit images along with historical data of digital photographs and videos using a plurality of text, or audio, or combination of both, in the same file; thereby, allowing the image and the data files to be filed, emailed, printed or presented on social media, photo sharing, and photo publishing and other websites as one file.

### BRIEF DESCRIPTION OF THE DRAWINGS

The subject matter that is regarded as the invention may be best understood by reference to the following description taken in conjunction with the accompanying drawing figures in which:

FIG. 1 shows a system for digitally storing data;

FIG. 2 shows electronics of an image capturing device used in the system of FIG. 1;

FIG. 3 shows a video display of the image capturing device of FIG. 2;

FIG. 4 shows a first portion of a method of digitally storing data using the system of FIG. 1;

FIG. 5 shows a second portion of the method of digitally storing data using the system of FIG. 1; and

FIG. 6 shows a third portion of the method of digitally storing data using the system of FIG. 1.

### DETAILED DESCRIPTION OF THE INVENTION

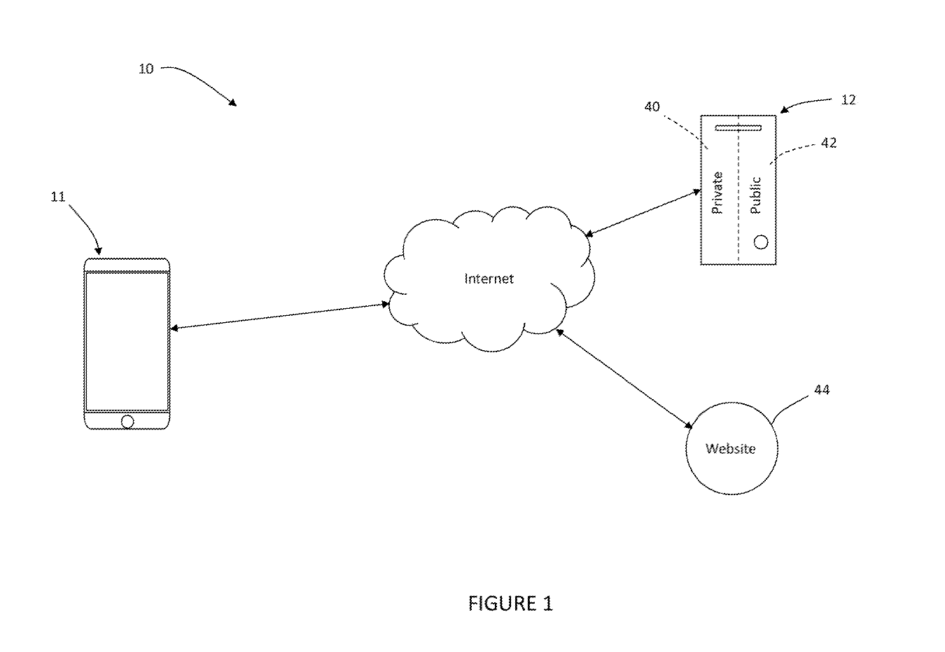

Referring now specifically to the drawings, a system and/or apparatus and method for digitally storing data is illustrated in FIG. 1 and shown generally at reference numeral 10. In general, the system 10 uses an image capturing device 11 and a cloud portal 12 (e.g. storage by a third party server over the internet) to upload data to, download data from, and store data for sharing over an Internet connection or other wide area network.

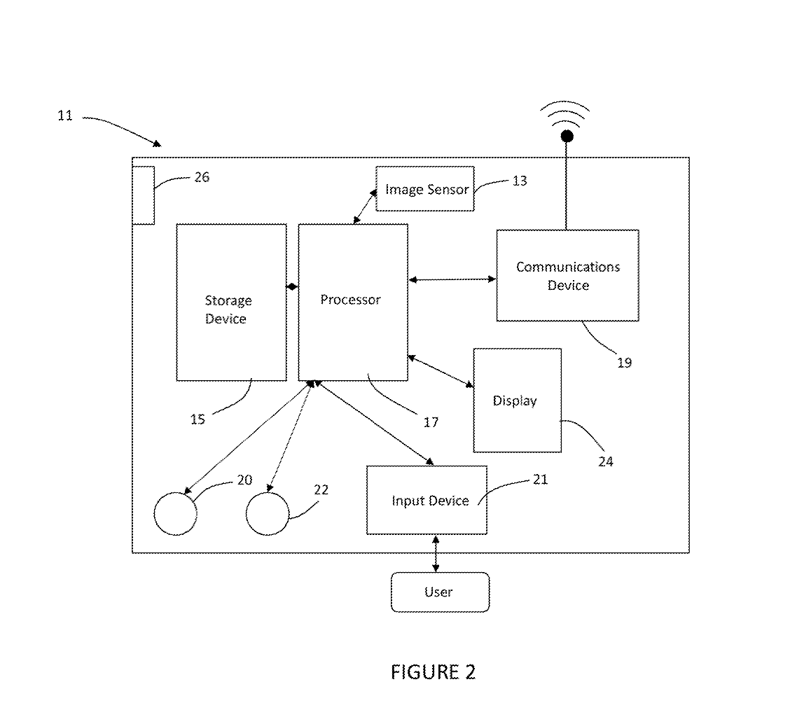

In general, a suitable image capturing device 11, FIG. 2, would include electronics (including but not limited to an image sensor 13 operable to generate image data, a storage device 15 operable to store image data and audio data (may be on-board storage, portable storage such as an SD card, and/or a combination of both), a controller or processor 17 to process data and instruct the image capturing device 11 to perform specified functions, a communications device 19 to transmit and receive data, and an input device 21 such as buttons, a keyboard and/or touch screen using resistive, capacitive, or surface acoustic wave technologies to recognize a user's touch). The image capturing device 11 may also include a microphone 20 configured to receive audible sounds and/or data, such as speech, background noise, etc., a speaker 22 to allow a user to hear audible sounds recorded by the image capturing device 11 during playback, and a video display 24 to view captured images during playback. The image capturing device 11 may also include a data connection 26 such as Universal Serial Bus (USB) to allow the image capturing device 11 to be connected to a computing device to download data from the image capturing device 11. It should be appreciated that suitable image capturing devices include smartphones, tablets, digital cameras, digital video recorders, and any other suitable digital device capable of being programmed by software, capturing image and audio data, transmitting and receiving data, storing data, editing data, and managing and presenting images along with historical data of digital photographs and videos using text, or audio, or a combination of both in the same file.

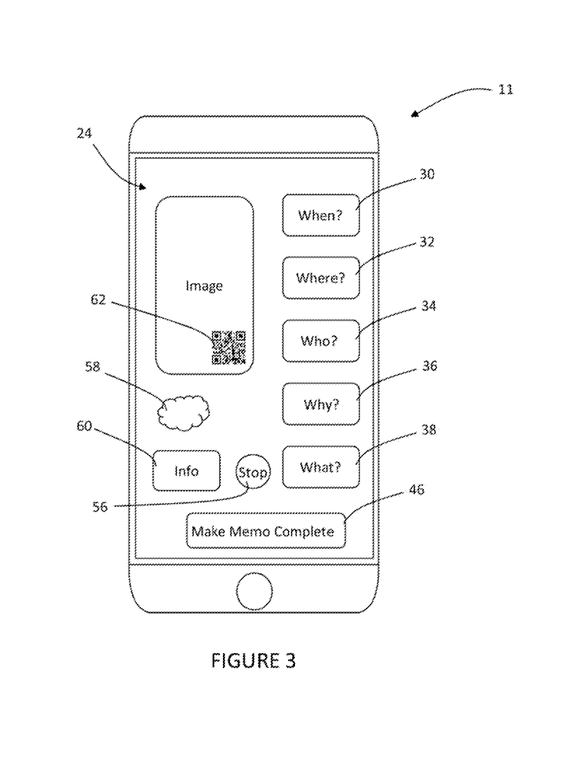

Referring to FIGS. 3-6, the system 10 utilizes a computer-based software application (“APP”) having a plurality of integrated software functions adapted to integrate with software and features of the image capturing device 11, including but not limited to metadata capture, image editing, speech recognition, facial recognition, and voice to text conversion software. It should be appreciated that the term APP may refer to application software (causes a computer to perform tasks), mobile applications (software designed to run on smartphones and other mobile devices), and web applications (software designed to run inside a web browser). The APP is configured to integrate with known software platforms such as Google's Android and Apple's iOS platforms. The software functions include: (1) audio function, (2) text function, (3) image capture function, (4) print function, (5) storage function, (6) share function, (7) editing function, (8) input function, and (9) memo management function. Other suitable functions may also be included.

In general, the software functions allow data to be edited and shared by the original user and others designated by the user. It allows consumers to seamlessly share with and receive information from others they select who can also add and edit the data and return it to the owner for acceptance or further edits until the historical context of the event is complete to the satisfaction of its owner, who can then save the file for posterity. Fields and content are managed using colored icons in a manner that track the progress of completion for text or audio data entries. In addition to user functionality, the APP allows licensed advertisers to embed the APP into images used in their advertisements to provide audio information about their product or service to viewers by tapping or clicking on an icon displayed in their product or service images. For purposes of clarity, the following discussion of the system and method will be with reference to a smartphone application. It should be appreciated that while the following discussion is directed to smartphones, the system and method is not limited to smartphones and applies to other digital media and image capturing devices as discussed above.

The software functions produce a compilation of files that allow users to capture critical content in the form of digital photography and specific types of audio and text files into a single protected file extension “.Memo”. The file extension (called a folder throughout this document) is written in a binary format and creates a new communication medium for capturing and sharing photographic memories. The folder stores data surrounding one unit of work as a single image format such as a JPEG image file or video file or any other suitable image format. All other data in the folder relates to this one image or video file.

The folder contains one JPEG or video computer file, a series of computer text (TXT) files, and one or more computer AMR (a lossy audio compression format) audio files for an image capturing device's built in audio/voice recognition software. It should be appreciated that other file types may be included as well. The APP applies the suffix to the base file name of the JPEG or video computer file (separated from the base file name by a dot) which the APP applies to indicate the encoding (file formats) of the additional contents (files) created by the user as a folder. The name of the JPEG, video file, audio file, or any combination of these files (now called a Memo) is preset by the APP (the timestamp pulled from the metadata of the JPEG, as an example), but can be renamed by the user. The APP places the three file types available in the image capturing device's software systems: JPEG for images and/or video files and their selected metadata (discussed later in this document), audio, and text into a single Memo in a pre-determined order. Data in every Memo is encrypted.

The APP's audio function uses the image capture device's microphone 20 to capture two types of audio files: (1) ambient and (2) structured/unstructured commentaries. The APP integrates with the audio recording software on the user's image capturing device 11 to capture the audio files. Once the audio files have been captured, the controller 17 directs the audio files to the storage device 15 along with a captured image.

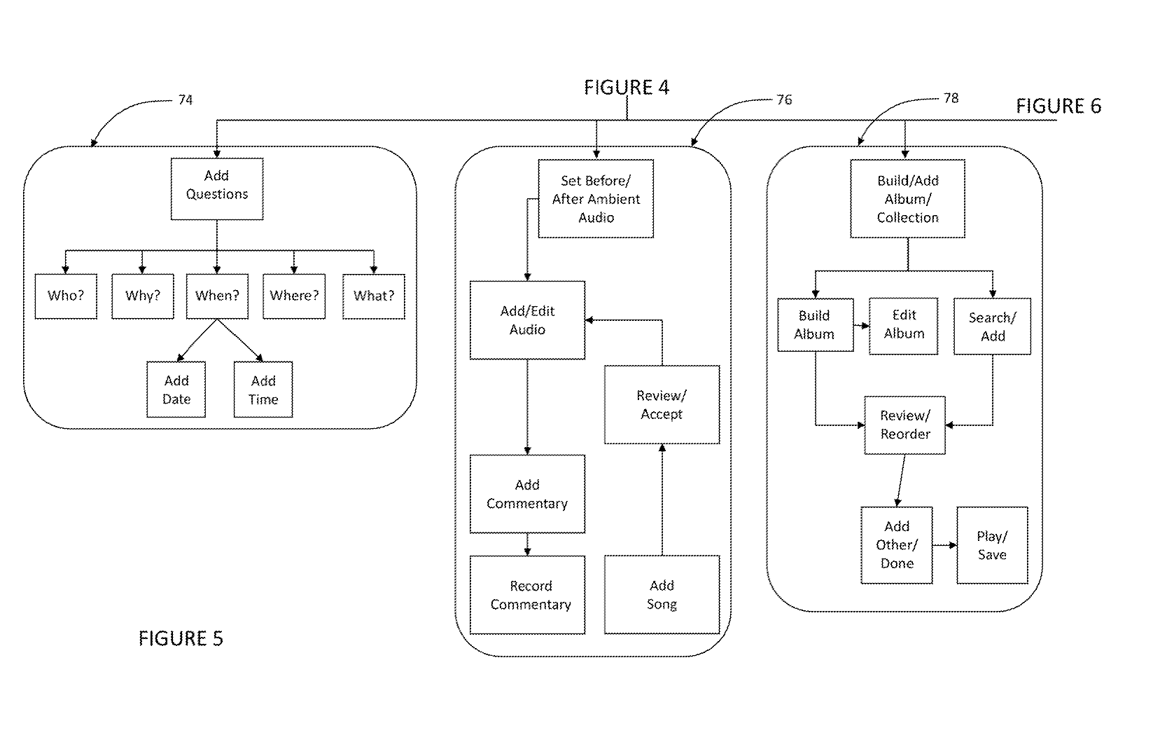

Ambient audio capture allows a user to capture ambient noise occurring around him/her for a pre-determined amount of time before the image capture function exposes the image to the image sensor 13, during exposure, and after the image has been captured by the image sensor 13. It should be appreciated that the pre-determined times may be referenced from the time stamp of the image, as well. For example, the pre-determined amount of time may be any number of seconds between 1 and 59 seconds or any number of minutes between 1 and 10 minutes or any combination of minutes and seconds. The following applies to ambient audio (See FIG. 5, Block 76):

1. The user can set the duration of the ambient audio capture for various durations of time (seconds/minutes) before or after exposing the image sensor 13 to an image by using a “Settings” feature in the APP.

2. Ambient audio capture can be deactivated at the discretion of the user or turned “on” to allow a user to capture audio files throughout the day.

3. Ambient audio capture can be edited (e.g. deletion of certain portions of the audio file, volume adjustments, etc.) or deleted entirely by the user.

4. Ambient audio capture may become structured for commercial applications.

5. Ambient audio capture may become structured over time as the user of the APP becomes more skilled at providing his/her own audio commentary during the time period settings before and after the image is captured.

Structured and unstructured commentary audio capture provide multiple options for users and others to record commentary about an image captured on the image capturing device 11 using audio and/or text entries. For text entries, the APP's text function integrates with the image capturing device's voice-to-text conversion software or the text entry may be manually entered using the input device 21. These commentaries can also be captured on images imported from another device. These are structured, user driven data entries made by the user and others selected by the user. These data entries may also be made by the APP through automatically extracting selected portions of metadata located in the JPEG file after the image is captured. The user and others selected by him/her have options about how to enter commentaries.

Unstructured commentaries may be of any duration and include entries as audio and/or text files. Audio data entries may be automatically saved to the storage device 15 as text files through integration with the device's voice-to-text conversion software. Unstructured commentaries are “free form” commentaries that the user and others selected by him/her can enter as audio or text files to provide historical commentary, humorous comments, anecdotes and other narratives about the image important to the user and others he/she selects to provide them. Each contributor can edit their comments, but once sent back to the user only he/she can make final edits.

Structured commentaries feature answers to five one-word questions described below and presented to the user in the following sequence (See FIG. 5, Block 74). The first three one-word questions in the structured commentaries are gleaned from metadata of the software the image capture device 10 uses to produce the JPEG and is presented to the user on the image capture device's video display 24. The input function uses the video display 24 to prompt the user to answer the following questions by displaying an icon for each of the five one-word questions. The icon may be pressed by the user to allow the user to answer the questions using the audio and text functions. The five one-word questions are as follows: (1) When?, (2) Where?, (3) Who?, (4) Why?, and (5) What?. Each of the one-word questions are described below.
1. When?: This information is automatically presented to the user when the input function presents the “When?” icon 30 on the video display 24. The information is pulled from the metadata of the JPEG image and/or video. “When?” is received from the JPEG file as an automated text file, but the user can enter this information using text or voice-to-text conversion software if preferred. Both automated and manual entries can be edited only by the user that created the Memo.
2. Where?: The input function automatically retrieves this information from the metadata of the JPEG and/or video file. In addition, the input function may present the “where?” icon 32 on the video display 24. To protect the privacy of the user, they must select an option to make this information visible in their Memo files. The metadata is provided via global positioning satellite (GPS) information or other location information sources received and downloaded by the image capturing device's communications device 19. The GPS function must be enabled in the image capturing devices software. If authorized by the user, “Where?” will be received from the JPEG file as a text file and entered into the visible portions of the Memo folder. It can be edited at any time by the user.
3. Who-1?: The input function automatically captures and presents this information to the user as it is pulled from the metadata of the JPEG file and typically refers to the name of the person owning the image capture device 11. Several options can be selected by the user, including placing a copyright indicia © and date on the front of the image. The owner of the image capture device 11 has the option to change “Who” in the event someone else, with the owner's permission, is the user. Both automated and manual entries can be edited only by the user.
4. Who-2?: This data must be manually entered by the user by depressing the “Who?” icon 34 and using the audio and text functions unless he/she has facial recognition software, in which case, the APP will integrate with the facial recognition software and activate it. Even if facial recognition software is activated, the user and others may be required to enter names either through the audio function or text function if the software does not recognize the persons.

5. Why?: This data must be manually entered by the user and others he/she selects to provide commentary by depressing the “Why?” icon 36 and using the audio and text functions to describe why the image was captured and why it is important. If the audio function is used, the image capture device's voice to text conversion software may be used to convert it to text as a method to help produce redundancy in data capture and make data recall easier for the user and others.

6. What?: This data must be manually entered by the user and others he/she selects to provide commentary by depressing the “What?” icon 38 and using the audio and text functions. This data provides the results, consequences, and perhaps outcomes following the event. If the audio function is used, the image capturing device's voice to text conversion software may convert it to text as a method to help produce redundancy in data capture and make data recall easier for the user and others. Each Memo requires a title to be entered in to the “What” section to assist in the search function if uploaded to the cloud portal 12. In addition to manual entry of data, the user may direct the APP to download information pertinent to the image. For example, if the image captured is of the Eiffel tower, the user can direct the APP to download information on the Eiffel tower from websites such as Wikipedia and/or download the weather for the day the image was captured. by pressing an “Info” icon 60.

While it is preferred to follow the sequence described above, it should be appreciated that the order questions may be modified, shuffled, or reconfigured by the user.

The APP's text function uses the image capturing device's input device 21 and controller 17 to create two types of text files—unstructured and structured commentary. Search, capture and retrieval of selected metadata from the image capturing device's software are structured commentaries and are retrieved by the controller 17 from the storage device 15 and/or communications device 19. Other commentaries created by users of the APP are considered unstructured commentaries. Data entry by text is provided as an option for the user and others he/she selects to participate in creating and saving each Memo. The text function, when possible, automatically converts audio files to text files using the image capturing device's voice to text conversion software. The text function also allows spelling and grammar correction, font type and size manipulation, and, for structured commentary, will utilize the software function icons to answer the one-word questions described above.

The APP allows Memos to be combined and aggregated into albums and/or collections and stored on the storage device 15. These albums and/or collections also include aggregated audio and text files (See FIG. 5, Block 78).

In addition to the image capturing device's storage device 15, Memos may be saved to the cloud portal 12 using the communications device 19. The cloud portal 12 allows the Memos to be saved in two separate locations—a private portal 40 and a public portal 42. It should be appreciated that the cloud portal 12 may be petitioned into the private and public portals 40 and 42 or that the private and public portals 40 and 42 represent two separate cloud portals 12. The private and public portals 40 and 42 may be set by users and may be edited at any time using the image capturing device 11, other mobile devices, and/or a computing device such as a desktop computer. The private portal 40 allows the user to store Memos privately while the public portal 42 allows the user to share or publically post Memos with the public or with a limited group such as “Friends and Family”. The public portal 42 also permits user designated by the user to make edits and/or additions to the Memo. The user settings for the public portal 42 may be modified at any time by the user. A cloud icon 58 is displayed next to the Memo when the Memo has been saved to the cloud portal 12. If a cloud icon 58 is not displayed, then the Memo has not been saved to the cloud portal 12.

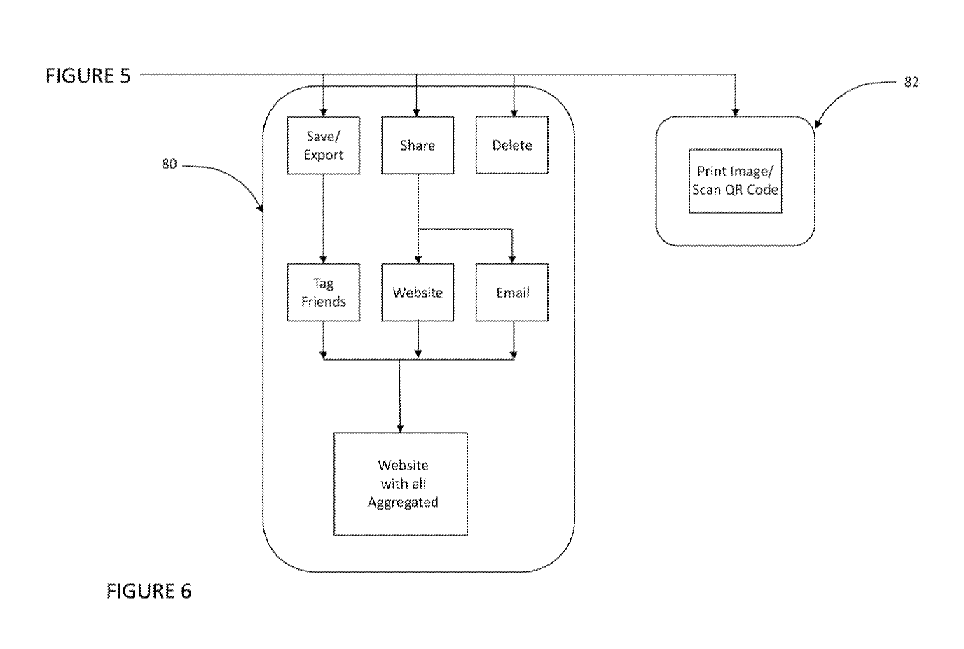

As discussed above, a user may share his/her Memos with the public, with a limited group of users, or not at all. For example, they can be shared on social media sites, emailed, sent in text messages and printed. They can be stored and shared by their owners on desktop computers, mobile devices, or on a designated website 44 associated with the APP (See FIG. 6, Block 80).

If using the website 44, the website 44 provides “flagging” functionalities to allow all users of the website to object to a Memo posted on the website that they find offensive. If a pre-determined amount of “flags” within a specified period of time occur, the Memo is removed for third party review and depending on the outcome of the third party review, possibly removed permanently.

The Memo management function allows a user to search and manage Memos saved to the storage device 15, the cloud portal 12 (private and public), and/or the website 44. For each Memo, a “Title” must be given before the APP will save it to the cloud portal 12 and/or the website 44 from the image capturing device 11, a mobile device, and/or desktop computer. Further, the user must declare whether the Memo was created by an image capturing device using the APP or recently converted from an analog state to a digital file.

Paper images, slides, and other non-digital imagery (described as analog imagery) items can be converted to digital files (e.g. JPEG files) and further converted to Memos on the image capturing device 11, mobile devices, and/or desktop computer using the APP. It should be appreciated that prompts and/or icons may differ slightly from one platform to another because the APP integrates into the operation platforms of these devices which may differ slightly from one another.

The APP always prompts users to complete as many of the questions, described above, as possible to retain as much of the historical context of the image as possible. The APP allows users to opt out of this functionality, or indicate that all the questions known to the user have been answered, by pressing an “Make Memo Complete” icon 46 on the video display 24.

The APP also allows “key word” searching for Memos. The search is designed around the title, followed by the key words using in the questions, structured text entries, and audio commentaries that have been converted to text files.

The print function allows Memos to be printed by all known photo printing processors that print JPEG files. Traditionally, when customers have their digital photos printed at retailers the digital file is simply identified as a JPEG file—its origin cannot easily be identified. A Memo provides detailed documentation within the encrypted Memo that traces and identifies the file as having been created by the APP and any participating licensee associated with the Memo being printed.

The APP's unique file extension “.Memo” enables the APP and licensed users of the technology to be able to participate in revenue sharing opportunities created when APP users have their Memos printed at retailers providing photo processing services. The APP presents Memos to participating retailers and consumers as a .Memo file on viewing devices provided by photo processing retailers to customers. The presentation of the files as “.Memo” is used so that the retailer knows that a discretely numbered file format is presented to the retailer for printing and revenue sharing.

Memos may be printed on any size paper or object to which an image may be adhered to, including, as examples, shirts, coffee mugs, canvases, posters, to name a few. The printing capabilities of .Memo files are only limited by the devices on which they are printed. The presentation for printing may be made through in store kiosks, smartphone Apps, and desktop computer software supplied to consumers by the retailers or participating authorized licensees.

The print function allows Memos to be printed and transferred to retailers using three options. The first option allows the user to print only the digital image file, or JPEG. The second option allows the user to print the image and text files in any manner consistent with the capabilities of the photo processing equipment of the retailer. A quick response (QR) code 62, or similar code or technology, that will allow access to audio files stored at the website 44 may or may not be included in the printed text. The third option is associated with the second option. It allows viewers of the printed Memo to use the QR Reader on their image capturing device 11 to listen to the audio file associated with the Memo on the website 44 that stores the Memo audio file.

As discussed above, the print function may use a QR code 62 to access files. A QR code is a type of matrix barcode (two-dimensional barcode). It is a machine-readable optical label that contains information about the item to which it is attached. The QR code 62 uses four standardized encoding modes (numeric, alphanumeric, byte/binary, and kanji) to efficiently store specific data. The specific data in the present case directs the user to a specific Memo audio file located at the website 44. Its purpose is to enable the user to hear the audio file associated with the Memo in its entirety on their image capturing device 11. For example, if a Memo is printed with a QR code 62 and hung on a wall, a passerby may scan the QR code 62 with his/her smartphone and then hear the audio file associated with the image.

The QR code 62 is made of black modules (square dots) arranged in a square grid on a white background, which can be read by the image capturing device 11 and processed using Reed-Solomon error correction until the image can be appropriately interpreted and used. Users of the APP will be encouraged to download to their image capturing device 11 a free QR code App from an approved vendor. The APP will provide suggestions for the type of QR code 62 to download to make certain that the QR codes used in the APP will have optimum black and white contrasts for when a QR code reader is used. The intent is to ensure connectivity between the image capturing device 11 and the website 44 to which it is directed.

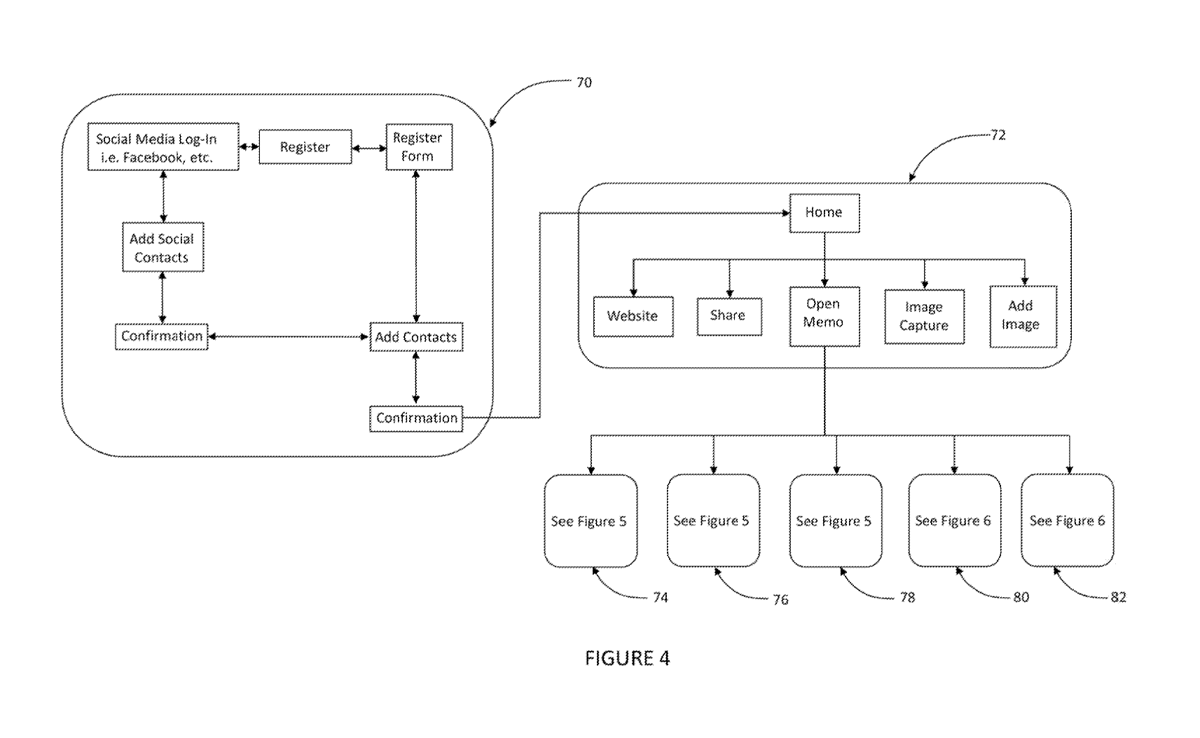

In use, the system functions in the following manner.
Step 1—The APP resides on website 44 or other licensed websites for downloading to an image capturing device 11 (See FIG. 4, Block 70).
Step 2—Once downloaded the user can elect to associate the APP with one or more digital images or video files currently residing on the image capturing device 11 and he/she may then begin data entry concerning the content of the image and/or video event(s) (See FIG. 4, Block 72).
Step 3—A series of icons 30, 32, 34, 36, and 38 appear beside the digital image or video file indicating an active license of the technology and enabling the user to begin the process of entering data representative of the questions and/or other data the user wishes to enter. The first status icon 48 (a specific color like red) indicates the APP is attached to the image and structured or unstructured audio and/or text data collection can begin. The APP allows for auto-population of certain data by searching the user's image capturing device 11 for stored metadata information relevant to the image and/or video file. Such data includes the use of facial recognition software, geotagging of locations and date and time stamps residing in most digital devices (See FIG. 5, Block 74).
Step 4—When the user clicks on one of the icons 30, 32, 34, 36, and 38 a data entry screen containing data entry fields appears for each icon. As the user enters data about the image or video, the APP digitally stores the history of the event by allowing the user to record any or all of the following, in text or verbally; “who” took the image/video, “who” is in the image/video, “why” was the image/video taken, “where” was the image/video taken, “what” was the reason for the image/video, and “when” was the image/video taken. If the user chooses to add additional information they can do so. The user has the option to fill in any, all, or none of the data fields provided. The user may also add additional data entry fields (See FIG. 5, Block 74).
Step 5—Once structured data collection for the questions has been entered a second status icon 50 (a specific color like yellow) appears on the front of the image/video Memo indicating that some content has been entered (See FIG. 5, Block 74).
Step 6—After data has been collected to the satisfaction of the user and he/she has indicated that by clicking on a “finished” icon 52 on the data collection screen, a third status icon 54 (a specific color like green) appears on the front of the image/video Memo. This indicates that data has been added to all fields and is placed in the Memo. The owner of the Memo has edit privileges and can designate others who might have the same privileges. The APP allows users to share the image/video Memo and the data fields on the Internet through various licensed image publishing websites or social media websites where he/she is linked (See FIG. 5, Block 76).
Step 7—The audio feature of the smartphone or computer can be “on” at the option of the user so that the user of the software can capture audio throughout the day. As a result the user can initiate audio at any time (See FIG. 5, Block 78).
Step 8—When an image is captured on the image capturing device 11 by the user, the APP captures the audio for the preset time period immediately preceding the capture, and for a preset time following it (See FIG. 5, Block 78).
Step 9—The audio recording remains on during the capturing process for as long as the user, and other sounds are present, for up to an additional preset period of time, or until no discernible audio sound levels are detected, or the user manually stops the recording by pressing a stop recording icon 56 on the video display 24 (See FIG. 5, Block 78).
Step 10— The APP will automatically convert the structured and unstructured audio and combine them in the Memo as a text version of the audio file if this functionality is available on the image capturing device and is activated by the user (See FIG. 5, Block 78).
Step 11— The APP allows the user to preset time periods, including combined text and/or audio, Block 78, that can then be aggregated into albums or collections and stored as such (See FIG. 6, Block 80).
Step 12—The APP allows the user to share the images with friends using the website 44 or other social media site. Additionally, the APP allows the user to aggregate all information regarding the image, such as tagged friends, email, etc. to the website 44 (See FIG. 6, Block 80).
Step 12— The APP uses encryption to protect the entire Memo file's content.
Step 13—The APP is used to decrypt the Memo and make the content available to the user and/or any designated users.

The APP may also be used by a user to convert analog content to a digital format (See FIG. 4, Block 72); to facilitate, in a desktop environment, the publication of image related books, prints, ancestral compilations, and an array of relevant historical documents; to print JPEG and text components of Memos on any known printing device that accepts JPEG files while providing discrete encrypted files (See FIG. 6, Block 83); to use QR codes to allow viewers of Memo prints to experience the audio captured by the APP by using QR readers; to schedule reminders to remember specific events that are preserved as Memos, either on their image capturing device 11 or on website 44 or any other approved website; to add their favorite songs to Memos, albums, and/or collections either by download or import from their image capturing device 11; to send requests for commentaries from others who have the APP or desktop software on specific memories that have been preserved as Memos; and to allow licensed entities with online ads to convert them to online Memos so that much larger amounts of information can be presented within the same digital ad.

The foregoing has described a system and method for digitally storing data. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

What is claimed is:

1. An apparatus configured to digitally store data, comprising:
(a) an image capturing device configured to capture image data and content data associated with the image data thereon; and
(b) a software application disposed on the image capturing device, the software application including a plurality of software functions configured to allow a user to capture and modify the image data and content data, wherein the software functions compile the image data and content data into a single folder having a unique file extension for use by the user.

2. The apparatus according to claim 1, further including a portal configured to connect to the image capturing device over a network and store the folder.

3. The apparatus according to claim 1, wherein the content data is selected from the group consisting essentially of audio data, text data, weather data, and geo-positional data.

4. The apparatus according to claim 1, further including a website configured to allow a user to upload and share the folder with other users.

5. The apparatus according to claim 1, wherein the portal includes a private portal configured to allow the user to access the folder and a public folder configured to allow the user and other designated users to access the folder.

6. The apparatus according to claim 1, wherein the image capturing device includes:
(a) an image sensor operable to generate image data;
(b) a microphone operable to generate content data in the form of audio; and
(c) an input device operable to generate content data in the form of text.

7. A method of generating or making a multimedia file, comprising the steps of:
(a) using an image capturing device to capture image data and content data; and
(b) using a software application disposed on the image capturing device to compile the image data and content data into a single folder having a unique file extension.

8. The method according to claim 7, further including the step of storing the folder for access by a user.

9. The method according to claim 7, wherein the content data includes structured and unstructured data.

10. The method according to claim 9, wherein the structured data includes answers to one-word questions.

11. The method according to claim 9, wherein the structured data includes metadata.

12. The method according to claim 7, further including the step of editing the image data and content data compiled in the folder.

13. The method according to claim 9, wherein the structured data includes audio data, the method further including the step of converting the audio data to text data.

14. The method according to claim 7, further including the step of encrypting the folder.

15. A method of generating or making a multimedia file, comprising the steps of:
(a) associating a software application with one or more digital images or video residing on an image capturing device;
(b) using the image capturing device to enter descriptive data, the descriptive data including structured and unstructured commentary;
(c) using the software application to compile the image or video and descriptive data into a single folder having a unique file extension; and
(d) uploading the folder to a portal for storage.

16. The method according to claim 15, wherein the portal includes a private portal configured to maintain the folder in privacy and a public portal configured to permit designated users to share, edit, and use the folder.

17. The method according to claim 15, wherein for the structured data, the method further includes the steps of accepting user input in response to structured questions and storing answers to the structured questions as a text file within the folder.

18. The method according to claim 17, wherein the structured questions are selected from the group consisting essentially of where?, who?, when?, why?, and what?.

19. The method according to claim 17, wherein the user input is entered using an input device of the image capturing device.

20. The method according to claim 15, further including the step of placing a quick response code in the folder and associating it with the image data to permit a user to scan the quick response code and listen to audio data associated with the image data.
